(19) United States
(12) Patent Application Publication
(10) Pub. No.: US 2014/0344079 A1
(43) Pub. Date: Nov. 20, 2014

(54) ELECTRONIC DEVICE, SYSTEM FOR INSERTING ADVERTISEMENT TO MEDIA FILES AND METHOD THEREOF

(71) Applicant: Power-All Networks Limited, Shatin (HK)

(72) Inventor: STEVE LAP WAI HUI, Shatin (HK)

(73) Assignee: Power-All Networks Limited, Shatin (HK)

(21) Appl. No.: 14/278,758

(22) Filed: May 15, 2014

(30) Foreign Application Priority Data
May 16, 2013 (CN) 2013101815433

(51) Int. Cl. G06Q 30/02

(52) U.S. Cl. CPC G06Q 30/0277
USPC 705/14.73

(57) ABSTRACT

An method for inserting advertisement into media files, includes: inserting an advertisement into a media file in response to an inserting operation of a user. Controlling to display an integrated picture comprising a media file frame and an advertisement frame on a display unit of the electronic device after inserting the advertisement to the media file. Finally, adjusting a display proportion of the media file frame and the advertisement frame according to an adjustment operation of the user.

### CROSS REFERNCE TO RELATED APPLICATIONS

This application is related to the following co-pending, commonly assigned patent application, the disclosures of which are incorporated herein by reference in its entirety:
1. “ELECTRONIC DEVICE, SYSTEM FOR BROADCASTING ADVERTISEMENT AND METHOD THEREOF” by Steve Lap Wai Hui, whose Attorney Docket No. is US51801.

### FIELD

The present disclosure relates to systems, and particularly to a system and method for inserting advertisement in media files.

### BACKGROUND

Nowadays, in order to enhance awareness of a product, the product may be advertised in a number of ways. For example, the advertisement can be broadcasted via leaflet, television, or networks. However, such advertisement methods may not always be ideal.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device running a system for inserting advertisement into media files.

FIG. 2 is a block diagram of an embodiment of an integrated picture.

FIG. 3 is a flowchart diagram of an embodiment of a method for inserting advertisement into media files.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

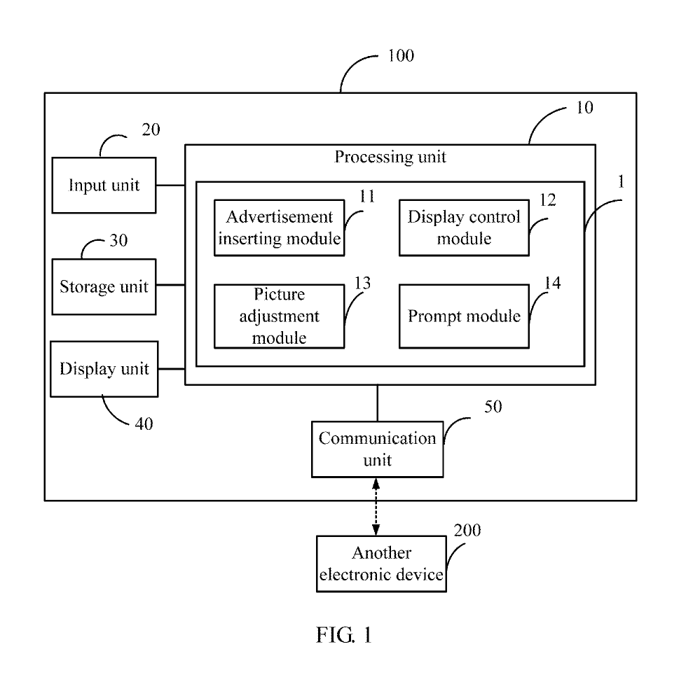

FIG. 1 illustrates an electronic device 100 of one embodiment. The electronic device 100 can include a processing unit 10, an input unit 20, a storage unit 30, and a display unit 40. The input unit 20 can be used to input data, the input unit 20 can be a touch screen, a keyboard, or a camera, for example. The electronic device 100 can be a mobile phone, a tablet computer, a desktop computer, or a portable computer, for example.

The storage unit 30 can store a number of media files, the media files can be downloaded from the cloud server 300, and can be input by the user via the input unit 10, such as video files captured by a camera. The media files include video files, audio files, word documents, for example.

The display unit 40 is used to display content of the media files and other information. In the embodiment, the input unit 20 and the display unit 40 can be independent units. In another embodiment, the input unit 20 can be combined with the display unit 40 to form an input/output unit, such as a touch screen.

The processing unit 10 executes a system 1 for inserting advertisement to a media file. In the embodiment, the system 1 is stored in the storage unit 30, and the system 1 can include a number of modules, which can be a collection of software instructions and can be executed by the processing unit 10. In the embodiment, the storage unit 30 can be a hard disk, a compact disk, or a flash memory. The processing unit 10 can be a central processing unit, a digital processor, or a single chip.

The system 1 can include an advertisement inserting module 11, a display control module 12, and a picture adjustment module 13.

The advertisement inserting module 11 can be used to insert an advertisement into a media file in response to an inserting operation of a user. In the embodiment, a user manually operating a particular key or a menu item can produce the inserting operation. When the input unit 20 is combined with the display unit 40 as in a touch screen, the inserting operation can be an operation of a user manually pressing the media file displayed on display unit 40 for a certain time, such as 2 seconds.

In the embodiment, the advertisement inserting module 11 can insert a predetermined advertisement into the media file. In at least one embodiment, the advertisement inserting module 11 can provide an advertisement list including a number of advertisements after the inserting operation is generated, the advertisement inserting module 11 then inserts an advertisement selected by the user into the media file.

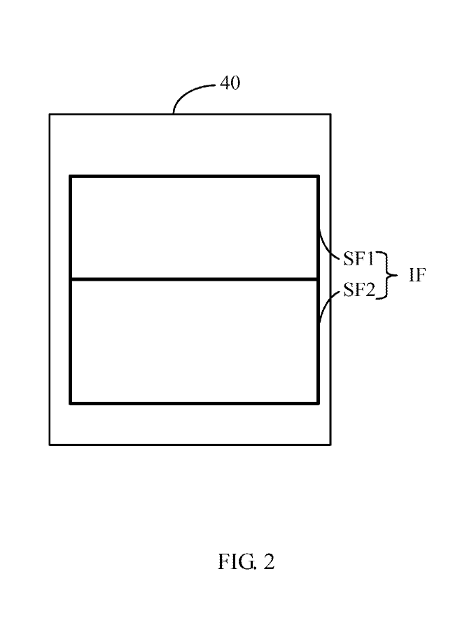

FIG. 2 illustrates that the display control module 12 can control to display an integrated picture IF including a media file frame SF1 and an advertisement frame SF2 on the display unit 40 after the advertisement inserting module 11 inserts the advertisement to the media file. In the embodiment, the display control module 12 can control a display proportion of the media file frame SF1 and the advertisement frame SF2 to a predetermined value, such as 1:1, when displaying the integrated picture IF.

The picture adjustment module 13 adjusts the display proportion of the media file frame SF1 and the advertisement frame SF2 according to an adjustment operation of the user. In detail, the picture adjustment module 13 adjusts the display proportion of the media file frame SF1 and the advertisement frame SF2 according to a drag operation on the media file frame SF1 or the advertisement frame SF2. For example, the picture adjustment module 13 can display the media file frame SF1 on one third of an area of the integrated picture IF and display the advertisement frame SF2 on two thirds of the area of the integrated picture IF according to the manual adjustment operation of the user, and thus adjust the display proportion of the media file frame SF1 and the advertisement frame SF2 to 1:2. In the embodiment, the drag operation on the media file frame SF1 or the advertisement frame SF2 can be to drag a common side of the media file frame SF1 and the advertisement frame SF2.

In the embodiment, the picture adjustment module 13 can store the display proportion of the media file frame SF1 and the advertisement frame SF2 of the integrated picture IF, when determining the adjustment of the display proportion of the media file frame SF1 and the advertisement frame SF2 has finished. Therefore, when the media file inserted in the advertisement is played, the media file frame SF1 and the advertisement frame SF2 can be displayed at the same time according to the display proportion. In the embodiment, the picture adjustment module 13 can determine the adjustment of the display proportion of the media file frame SF1 and the advertisement frame SF2 has finished when detecting no adjustment operation of the user for a predetermined time, such as 5 seconds. In at least one embodiment, the picture adjustment module 13 can determine the adjustment of the display proportion of the media file frame SF1 and the advertisement frame SF2 has finished according to a confirmed signal generated by a manual operation on a particular key or a menu item by the user.

In the embodiment, the system 1 can include a prompt module 14. The prompt module 14 can provide a prompting signal to prompt the user to adjust the display proportion of the media file frame SF1 and the advertisement frame SF2 after the display control module 12 displays the integrated picture IF including a media file frame SF1 and an advertisement frame SF2 on the display unit 40.

The display control module 12 further controls the media file frame SF1 and the advertisement frame SF2 to flash or vibrate if the user chooses to adjust the display proportion of the media file frame SF1 and the advertisement frame SF2, for example, the user can choose “Yes”. Thus the user can be prompted to drag the media file frame SF1 and/or the advertisement frame SF to execute the adjustment operation. In at least one embodiment, the display control module 12 does not control the media file frame SF1 and the advertisement frame SF2 does not flash or vibrate, and the user can drag the media file frame SF1 and/or the advertisement frame SF to execute the adjustment operation directly.

In the embodiment, the electronic device 100 can further includes a communication unit 50. The communication unit 50 is used to communicate with other electronic devices 200 via networks. The network between the electronic device 100 and the other electronic devices 200 can be an internet, a wireless network including WIFI and BLUETOOTH, a telecommunication network including a GPRS network and a CDMA network, or a broadcasting network, for example.

In the embodiment, the advertisement can be provided by an advertisement provider, or can be pre-stored in the storage unit 30. In detail, when the advertisement is provided by the advertisement provider, the advertisement inserting module 11 can link to a source address of the advertisement via a pre-stored website link of the advertisement, and then obtains the advertisement via the communication unit 50.

In the embodiment, the advertisement inserting module 11 can provide a prompt box T1 to prompt the user whether to insert the advertisement, and the advertisement inserting module 11 can insert the advertisement into the media file to be shared in response to an operation of choosing “Yes” by the user.

Therefore, according to the present disclosure, the electronic device 100 can insert the advertisement to the media files, and the advertisement can be played when one person opens/plays the media file, and the display proportion of the media file frame SF1 and the advertisement frame SF2 can be adjusted according to the user.

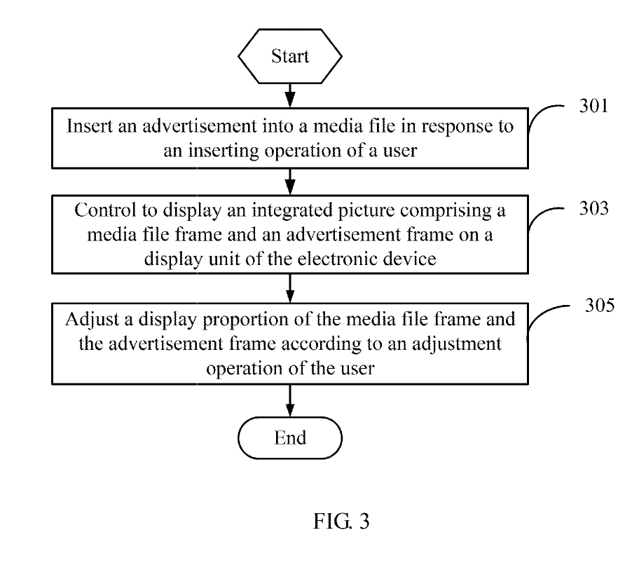

FIG. 3 shows a flowchart of a method for inserting advertisement into a media file. In 301, the advertisement inserting module 11 can insert an advertisement into a media file in response to an inserting operation of a user. In the embodiment, the advertisement inserting module can insert a predetermined advertisement into the media file. In another embodiment, the advertisement inserting module can provide an advertisement list including a number of advertisements after the user chooses to insert the advertisement, the advertisement inserting module then inserts the advertisement of the advertisement list selected by the user into the media file.

In 303, the display control module can control the display unit to display an integrated picture including a media file frame and an advertisement frame after the advertisement inserting module inserts the advertisement to the media file.

In 305, the picture adjustment module adjusts the display proportion of the media file frame and the advertisement frame according to an adjustment operation of the user. In the embodiment, the picture adjustment module adjusts the display proportion of the media file frame and the advertisement frame according to a drag operation on the media file frame or the advertisement frame.

In the embodiment, the method further includes a steps followes: the prompt module provides a prompting signal to prompt the user whether to adjust the display proportion of the media file frame and the advertisement frame after the display control module displays the integrated picture including a media file frame and an advertisement frame on the display unit.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for inserting advertisement into media files, running in an electronic device, the system comprising:
a processing unit; and
a plurality of modules which are collection of instructions executed by the processing unit, the modules comprising:
an advertisement inserting module configured to insert an advertisement into a media file in response to an inserting operation of a user;
a display control module configured to control to display an integrated picture comprising a media file frame and an advertisement frame on a display unit of the electronic device after the advertisement inserting module inserts the advertisement to the media file; and
a picture adjustment module configured to adjust a display proportion of the media file frame and the advertisement frame according to an adjustment operation of the user.

2. The system according to claim 1, wherein the advertisement inserting module is further configured to provide an advertisement list comprising a plurality of advertisements when receiving the inserting operation of the user, and then insert the advertisement selected by the user into the media file.

3. The system according to claim 1, further comprising a prompt module configured to provide a prompting signal to prompt the user whether to adjust a display proportion of the media file frame and the advertisement frame after the display control module displays the integrated picture on the display unit.

4. The system according to claim 1, wherein the picture adjustment module further stores the display proportion of the media file frame and the advertisement frame of the integrated picture, when determining the adjustment of the display proportion of the media file frame and the advertisement frame is finished.

5. The system according to claim 1, wherein the advertisement inserted into the media file is provided by an advertisement provider, or is pre-stored in a storage unit of the electronic device.

6. The system according to claim 5, when the advertisement is provided by the advertisement provider, the advertisement inserting module links to a source address of the advertisement via a pre-stored website link of the advertisement, and then obtains the advertisement via a communication unit of the electronic device.

7. An electronic device, comprising:
a storage unit configured to store a plurality of media files;
a communication unit configured to communicate with another electronic devices;
a display unit; and
a processing unit, comprising:
an advertisement inserting module configured to insert an advertisement into a media file in response to an inserting operation of a user;
a display control module configured to control to display an integrated picture comprising a media file frame and an advertisement frame on the display unit after the advertisement inserting module inserts the advertisement to the media file; and
a picture adjustment module configured to adjust a display proportion of the media file frame and the advertisement frame according to an adjustment operation of the user.

8. The electronic device according to claim 7, wherein the advertisement inserting module is further configured to provide an advertisement list comprising a plurality of advertisements when receiving the inserting operation of the user, and then insert the advertisement selected by the user into the media file.

9. The electronic device according to claim 7, further comprising a prompt module configured to provide a prompting signal to prompt the user whether to adjust a display proportion of the media file frame and the advertisement frame after the display control module displays the integrated picture on the display unit.

10. The electronic device according to claim 7, wherein the picture adjustment module further stores the display proportion of the media file frame and the advertisement frame of the integrated picture, when determining the adjustment of the display proportion of the media file frame and the advertisement frame is finished.

11. The electronic device according to claim 7, wherein the advertisement inserted into the media file is provided by an advertisement provider, or is pre-stored in the storage unit.

12. The electronic device according to claim 11, when the advertisement is provided by the advertisement provider, the advertisement inserting module links to a source address of the advertisement via a pre-stored website link of the advertisement, and then obtains the advertisement via the communication unit.

13. A method for inserting advertisement into media files, applied in an electronic device, the method comprising:
inserting an advertisement into a media file in response to an inserting operation of a user;
controlling to display an integrated picture comprising a media file frame and an advertisement frame on a display unit of the electronic device after inserting the advertisement to the media file; and
adjusting a display proportion of the media file frame and the advertisement frame according to an adjustment operation of the user.

14. The method according to claim 13, wherein the step of inserting an advertisement into a media file in response to an inserting operation of a user comprises:
providing an advertisement list comprising a plurality of advertisements when receiving the inserting operation of the user; and
inserting the advertisement selected by the user into the media file

15. The method according to claim 13, further comprising:
providing a prompting signal to prompt the user whether to adjust a display proportion of the media file frame and the advertisement frame after the displaying the integrated picture on the display unit.
